(19) United States
(12) Patent Application Publication
(10) Pub. No.: US 2011/0186148 A1
(43) Pub. Date: Aug. 4, 2011

(54) ESCUTCHEON

(76) Inventor: STEVEN G. DVORAK, Houston, TX (US)

(21) Appl. No.: 12/698,034

(22) Filed: Feb. 1, 2010

(51) Int. Cl. F16L 5/00

(52) U.S. Cl. 137/359

(57) ABSTRACT

An escutcheon is disclosed which comprises a generally circular structure having an outer diameter between 3 inches and 3-1/2 inches and having a centralized hole through which a plumbing pipe may be passed. Once an escutcheon in accordance with present invention is installed, in the amount of touch up work around the escutcheon is minimized if not eliminated.

### BACKGROUND OF THE INVENTION

1. Field of the Invention

The present invention relates to an escutcheon which is placed around a plumbing pipe where the plumbing pipe exits a structure containing the pipe.

2. Description of the Prior Art

Escutcheons are commonly used in the plumbing industry to cover a generally irregular hole which is formed in a wall or other structure to allow a pipe or fixture component to project through the wall. Normally, escutcheons are placed around pipes which feed hot or cold water to a faucet or other fixture and a common water pipe to a shower head or the like. Escutcheons are also used around taps or other control fixtures normally associated with showers, urinals and the like.

In practice, the holes which are formed in the surface of a wall are poorly cut, which results in a substantial amount of touch up work on the wall or other structure proximate the escutcheon after it is installed. This touch up work detracts from the efficiency with which they plumbing job may be accomplished, the appearance of the installation and the overall profitability of such a job.

A need exists in the plumbing industry for an escutcheon which eliminates the need for touch up work around it after installation and which is at the same time aesthetically pleasing. This novel and useful result has been achieved by the escutcheon of the present invention.

### SUMMARY OF THE INVENTION

In accordance with the present invention, an escutcheon is provided which comprises a generally circular structure with a centralized hole having a diameter through which a plumbing pipe may be passed and an outer diameter between 3 inches and 3-½ inches. An escutcheon having these dimensions will minimize, if not eliminate, the need for touch up work in the structure around the escutcheon after its installation.

### BRIEF DESCRIPTION OF THE DRAWINGS

In the accompanying drawings:

FIG. 1 is a drawing of an escutcheon in accordance with the present invention.

FIG. 2 is an front view of an escutcheon in accordance with the present invention.

### DESCRIPTION OF THE SPECIFIC EMBODIMENTS

It will be appreciated that the present invention may take many forms and embodiments. In the following description, some embodiments of the invention are described and numerous details are set forth to provide an understanding of the present invention. Those skilled in the art will appreciate, however, that the present invention may be practiced without those details and that numerous variations and modifications from the described embodiments may be possible. The following description is thus intended to illustrate and not to limit the present invention.

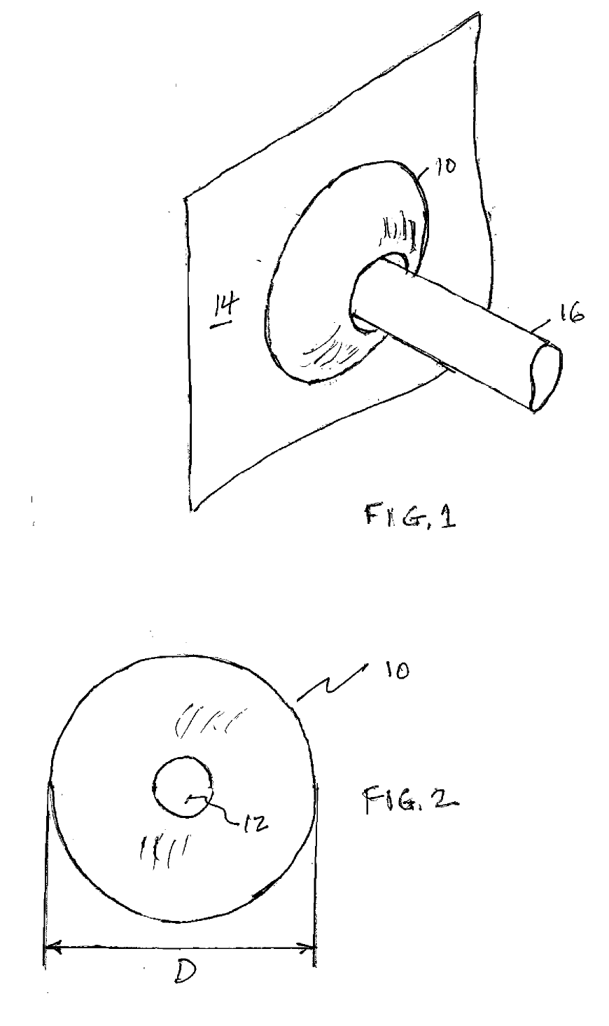

Referring to FIGS. 1 and 2, an escutcheon in accordance with present invention comprises a generally circular structure 10 with a centralized hole 12 through which a plumbing pipe 16 may be passed and an outer diameter D which is between 3 inches and 3-½ inches. When the escutcheon 10 is installed proximate wall or other structure 14 using techniques which are well-known to those skilled in the art. An escutcheon in accordance with the present invention which has the foregoing dimensions will minimize, if not eliminate, the need for touch up work in the structure around the escutcheon after its installation.

What is claimed is:

1. An escutcheon which comprises a generally circular structure having an outer diameter between 3 inches and 3-½ inches and which has a centralized opening through which a plumbing pipe may be passed.
